(19) United States
(12) Patent Application Publication
(10) Pub. No.: US 2002/0080366 A1
(43) Pub. Date: Jun. 27, 2002

(54) Apparatus for measuring surface shape, lateral coordinate calibration method therefor, and optical member having been measured with said apparatus or method

(75) Inventor: Shigeru Nakayama, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/024,145

(22) Filed: Dec. 21, 2001

(30) Foreign Application Priority Data
Dec. 27, 2000 (JP) 2000-398968
Jan. 9, 2001 (JP) 2001-001818

(51) Int. Cl. G01B 11/02

(52) U.S. Cl. 356/512

(57) ABSTRACT

A surface shape measuring apparatus that can measure surface shapes of optical elements such as lenses and mirrors with high degree of accuracy, and a method for calibrating a lateral coordinate of the surface shape measuring apparatus, are disclosed.

This application claims the benefit of Japanese Patent applications No. 2000-398968 and No. 2001-001818 which are hereby incorporated by reference.

### BACKGROUND OF THE INVENTION

1. Field of the Invention

The present invention relates to a surface shape measuring apparatus for measuring a surface shape of an optical element or the like such as a lens or a mirror with a high degree of accuracy. The invention also relates to a method for measuring a coordinate in the surface shape measuring apparatus.

Recently, with demands for high-precision optical devices, precision of their constituent optical elements such as lenses and mirrors is trending higher. In such a circumstance, it is common practice to measure a surface shape of an optical element with an interferometer.

2. Related Background Art

When an interferometer is used as the surface shape measuring apparatus, it is necessary to establish a highly accurate correspondence between a lateral coordinate position of a surface to be measured and a lateral coordinate position of an image pickup surface used for capturing interference fringes. Here, the “lateral coordinate” refers to a coordinate that is defined within a plane orthogonal to an optical axis. For example in an X-Y-Z coordinate system as a three-dimensional orthogonal coordinate system, if Z-coordinate is defined along the direction of the optical axis, X-coordinate and Y-coordinate are referred to as lateral coordinates.

In the processing apparatus for manufacturing or processing an aspherical lens or an aspherical mirror or the like by grinding, a controlling method in which abrasion amount is controlled in terms of lateral coordinates of the target to be processed is widely used. Therefore, a high degree of accuracy in lateral coordinates is required for the surface shape measuring apparatus for measuring the precision of surface of the manufactured or processed aspherical mirror or the like. This also requires determining a correspondence or relationship between a lateral coordinate position on a surface to be measured and a lateral coordinate position on an image pickup surface for capturing interference fringes with a high degree of accuracy.

In order to determine the correspondence between a lateral coordinate position of a surface to be measured and a lateral coordinate position of an image pickup surface for capturing interference fringes, it is presupposed first that the shape measuring apparatus has been ideally manufactured, in other words, it is presupposed that the apparatus has been manufactured precisely in accordance with design values. Secondly, ray tracing is effected based on design values so as to calculate a lateral coordinate position on the surface to be measured and a lateral coordinate position on the image pickup surface of the image pickup section corresponding to that lateral coordinate position on the surface to be measured. In this way, relationship between the position on the surface to be measured and the position on the image pickup surface can be determined. Then, it will be possible to obtain information on the shape of the surface to be measured by analyzing interference fringes formed on the image pickup surface.

However, optical elements that actually constitute the surface shape measuring apparatus involve manufacturing errors and assembling errors. Due to these errors, the results of ray tracing simulation based on design values do not strictly agree with the actual optical path in the surface shape measuring apparatus. In usual measurements, such a disagreement does not matter seriously. But in the case of highly accurate interference measurement as described above, such a disagreement causes difficulty in establishing correspondence between the lateral coordinate position on the image pickup surface of the surface shape measuring apparatus and the lateral coordinate position of the surface to be measured, so that there is a problem that the shape of the surface to be measured cannot be measured with a high degree of accuracy.

As an apparatus that realizes surface shape measurement with a high degree of accuracy, there is a lightwave interferometer, which utilizes interference of lights. Especially, a Fiezeau interferometer, which is a common light path interferometer and has high stability, is often used.

In the Fiezeau interferometer, a light flux emitted by a light source is split into two light fluxes. Then, one of the light fluxes is incident on a surface to be measured and reflected so as to constitute a measurement light flux. The phase of the measurement light flux has been changed in accordance with the shape of the surface to be measured. The other light flux is reflected by a reference surface so as to constitute a reference light flux. And then, the measurement light flux and the reference light flux are caused to interfere with each other so that interference fringes are generated. Finally, analysis and calculation are effected based on the interference fringes so as to measure the surface shape of the surface to be measured.

Most of the conventional Fiezeau interferometers described above are constructed in such a way that a light flux with a large diameter is made incident on a Fiezeau lens that has a reference surface (or Fiezeau surface) so that the Fiezeau lens itself practically plays an additional role as a stop. Furthermore, little consideration has been made on the appropriate location of a stop in the Fiezeau interferometer, and in most cases the stop is provided at an arbitrary position.

However, in the case in which the Fiezeau lens itself functions as a stop or in the case in which a stop is provided at an arbitrary position without paying attention to its appropriate position within the Fiezeau interferometer as described above, wavefront disturbance due to diffraction phenomena caused by said stop will occur at a periphery of the light flux that has passed through the stop. Especially, at a peripheral portion of the surface to be measured, wavefront disturbance due to Fresnel diffraction will overlap over the interference fringes to be observed. This is a problem since this makes the highly accurate measurement of the surface shape impossible. In the prior arts, in order to eliminate influences of diffraction due to stops, measurement data corresponding to the peripheral portion of the surface to be measured are sometimes discarded or ignored. In this case, it is impossible to measure the shape of the peripheral portion of the surface to be measured. This is a serious problem when a surface with small radius of curvature is to be measured.

### SUMMARY OF THE INVENTION

The present invention was made in view of the aforementioned problems and its first object is to provide a method for calibrating a lateral coordinate of a surface shape measuring apparatus that can measure surface shapes of optical elements or the like such as lenses and mirrors with high degree of accuracy.

The second object of the present invention is to provide a surface shape measuring apparatus that can measure surface shapes of optical elements or the like such as lenses and mirrors with high degree of accuracy.

The third object of the present invention is to provide an optical member having been measured with the surface shape measuring apparatus or the calibration method for the apparatus.

A method according to the first invention that achieves the first object is a lateral coordinate calibration method for a surface shape measuring apparatus which measures a shape of a surface to be measured by causing a measurement light reflected from the surface to be measured and a reference light to interfere with each other and detecting with a detector a phase difference through the interference, the method comprising the steps of:

providing a reflecting optical element formed with a specific pattern and designed to generate a reflection wavefront substantially the same as the measurement light, and generating an interference image of the reflection wavefront from the reflecting optical element and the reference light on a detection surface of the detector;

detecting lateral coordinate information of an image of the specific pattern on the detection surface which is formed in connection with the generation of the interference image;

calculating a relationship between lateral coordinate information of the specific pattern on the reflecting optical element and the lateral coordinate information of an image of the specific pattern on the detection surface.

In the lateral coordinate calibration method for a surface shape measuring apparatus according to the first invention, it is preferable that said reference light be a reflection light from a reference surface.

In the lateral coordinate calibrating method for a surface shape measuring apparatus according to the first invention, it is preferable that said reflecting optical element comprise a reflection type diffractive optical element.

In the lateral coordinate calibrating method for a surface shape measuring apparatus according to the first invention, it is preferable that said specific pattern comprise a pattern composed of presence and absence of diffracting pattern formed on said reflection type diffractive optical element.

In the lateral coordinate calibrating method for a surface shape measuring apparatus according to the first invention, it is preferable that said specific pattern comprise a pattern composed of a plurality of apertures.

In the lateral coordinate calibrating method for a surface shape measuring apparatus according to the first invention, it is preferable that said specific pattern comprise a pattern composed of a plurality of light shielding portions.

In the lateral coordinate calibrating method for a surface shape measuring apparatus according to the first invention it is preferable that said specific pattern comprise a pattern composed of a plurality of annular apertures and annular light shielding portions that are alternately and concentrically provided adjacent to each other.

An apparatus according to the invention that achieves the second object is a surface shape measuring apparatus which measures a shape of a surface to be measured by causing a measurement light reflected from the surface to be measured and a reference light to interfere with each other and detecting with a detector a phase difference through the interference, comprising:

a relationship calculating portion which calculates lateral coordinate information of an image of a specific pattern on a detection surface, the image of a specific pattern being generated by providing a reflecting optical element formed with the specific pattern and designed to generate a reflection wavefront substantially the same as said measurement light so as to generate an interference image of the reflection wavefront from the reflecting optical element and the reference light on the detection surface of the detector, and a relationship between lateral coordinate information of the specific pattern on the reflecting optical element and the lateral coordinate information of an image of the specific pattern on said detection surface.

An apparatus according to the second invention that achieves the second object is a surface shape measuring apparatus which measures a shape of a surface to be measured by causing a measurement light reflected from the surface to be measured and a reference light reflected from a reference surface interfere with each other and detects a phase difference through the interference, the apparatus comprising a stop disposed at a position conjugate with said surface to be measured.

In the surface shape measuring apparatus according to the second invention, it is preferable that said stop be provided with an adjusting member.

In the surface shape measuring apparatus according to the second invention, it is preferable that said adjusting member comprise a moving unit which moves said stop to the position conjugate with said surface to be measured.

In the surface shape measuring apparatus according to the second invention, it is preferable that said adjusting member comprise a plurality of reflecting mirror portions and a mirror moving portion which moves the reflecting mirror portions in such a way that said stop and said surface to be measure are conjugate with each other.

### BRIEF DESCRIPTION OF THE DRAWINGS

FIG. 1 is a schematic diagram of a shape measuring apparatus according to the first embodiment of the invention.

FIG. 2 is a schematic diagram illustrating a reflection type diffraction optical element.

FIG.3 is a drawing illustrating a pattern for coordinate measurement according to the first embodiment.

FIG. 4 is a drawing illustrating a modification of a pattern for coordinate measurement according to the first embodiment.

FIG. 5 is a drawing illustrating a pattern for coordinate measurement according to the second embodiment.

FIG. 6 is a schematic diagram of a surface shape measuring apparatus according to the third embodiment of the invention.

FIG. 7 is a schematic diagram of a surface shape measuring apparatus according to the fourth embodiment of the invention.

FIG. 8 is a schematic diagram of a surface shape measuring apparatus according to the fifth embodiment of the invention.

### DETAILED DESCRIPTION OF THE PREFERRED EMBODIMENTS

In the following, embodiments of the present invention will be described with reference to the annexed drawings.

### FIRST EMBODIMENT

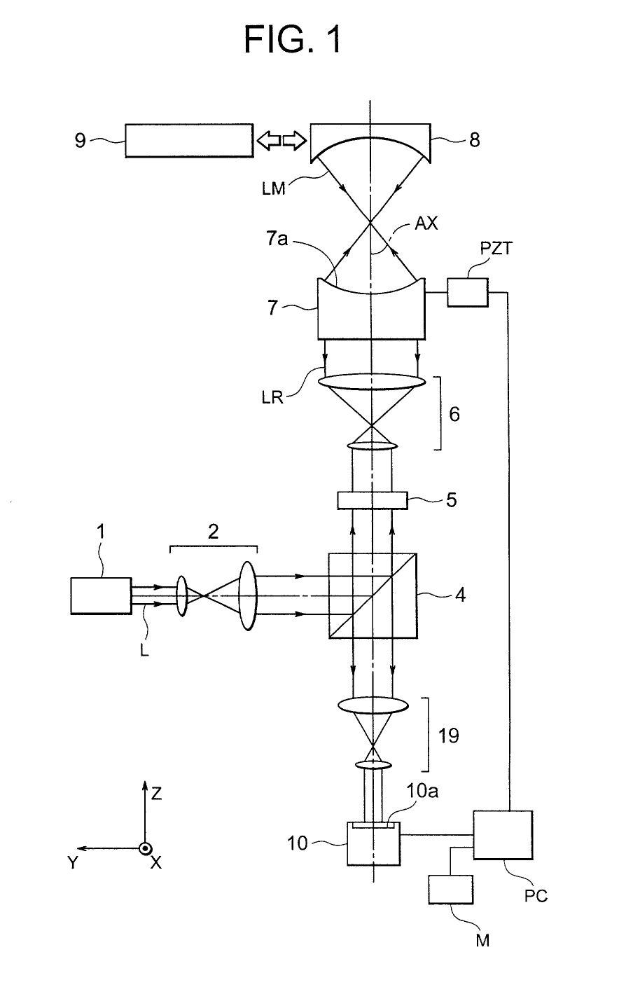

FIG. 1 is a diagram schematically showing the construction of a surface shape measuring apparatus according to an embodiment of the invention. In this apparatus, a linearly-polarized light beam L emergent from a laser source 1 is subjected to a beam diameter transformation by a beam expander 2 so as to be incident on a polarizing beam splitter (hereinafter referred to as “PBS”) 4. The polarization plane of the light beam L is so selected as to be reflected by the PBS 4. The light beam L reflected from the PBS 4 passes through a quarter wave plate 5 and a beam expander 6 so as to be incident on a Fiezeau lens 7. The light reflected from a Fiezeau surface 7a of the Fiezeau lens 7 is used as a reference light flux. The light passing through the Fiezeau surface is incident on a surface to be measured 8 as a measurement light flux.

First, a description will be made of the reference light flux LR. The reference light flux passes through, after reflected from the Fiezeau surface, the beam expander 6 and the quarter wave plate 5 again so as to be incident on the PBS 4. The reference light flux passes through the quarter wave plate 5 twice in its forward and backward paths, so that the plane of polarization thereof has been rotated by 90 degree. Therefore the reference light flux passes through the PBS 4 in its backward path. Next, the reference light flux is incident on a beam diameter transforming optical system 19 so that its diameter is transformed or varied and then the reference light flux is incident on a two-dimensional image sensor (or detector) 10.

On the other hand, the light having passed through the Fiezeau surface 7a is used as the measurement light flux LM. The measurement light flux is incident on a surface to be measured 8 disposed at a specific position, a diffractive optical element 9 of a reflection type or a reference standard (not shown). The reflection type diffractive optical element 9 will be described later. The measurement light flux is reflected by the surface to be measured while its phase is changed upon reflection in accordance with the shape of the surface to be measured 8. The measurement light flux reflected from the surface to be measured passes through the Fiezeau lens 7, the beam expander 6 and the quarter wave plate 5 again so as to be incident on the PBS 4. Similar to the reference light flux LR, since the measurement light flux passes through the quarter wave plate 5 twice in its forward and backward paths and the plane of polarization thereof has been rotated by 90 degree, the measurement light flux passes through the PBS 4 in its backward path. Next, the measurement light flux is incident on a beam diameter transforming optical system 19 so that its diameter is transformed or varied, and then the measurement light flux is finally incident on a two-dimensional image sensor 10.

Interference fringes generated by the interference between the reference and measurement light fluxes are detected on an image pickup surface 10a of the two-dimensional image sensor 10. It should be noted that the beam diameter transforming optical system 19 also functions to form an image of the surface to be measured 8 on the image pickup surface 10a of the two-dimensional image sensor 10.

An output from the two-dimensional image sensor 10 is fetched and analyzed by a computer PC so that a phase distribution of the interference fringes is calculated. The calculation result is stored in a memory M.

In the surface shape measuring apparatus of this embodiment, it is preferable that the surface to be measured 8 be slightly shifted in the direction of an optical axis AX by a piezoelectric element PZT so that the phase distribution of the interference fringes be obtained with a high degree of accuracy by means of a well known phase shift interferometry method.

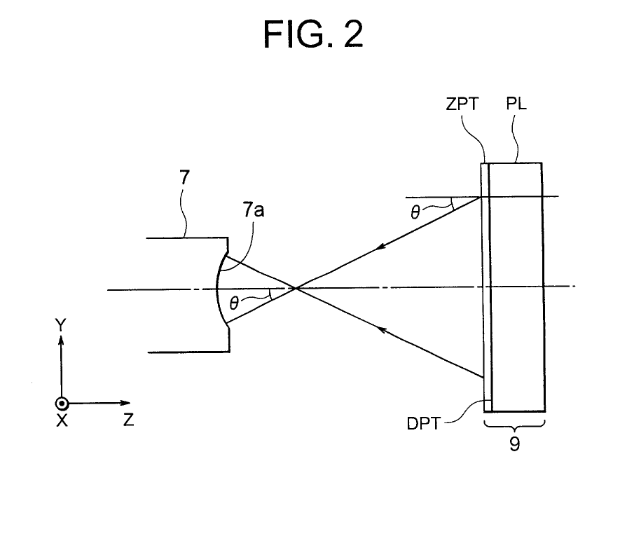

Next, the reflection type diffractive optical element 9 will be described with reference to FIG. 2. The reflection type diffractive optical element 9 is so constructed that a diffracting pattern DPT is formed on a planar plate PL. The diffracting pattern DPT is designed in such a way that an incident light flux will return along the path same as the forward or incident path. Here, such a reflection type diffractive optical element is used that when it is disposed at a position at which the surface to be measured is to be placed upon measurement, interference fringes as same as those interference fringes are generated that will be generated when the surface to be measured configured exactly as designed. A pattern mask ZPT for coordinate measurement is also provided adjacent to the diffracting pattern DPT.

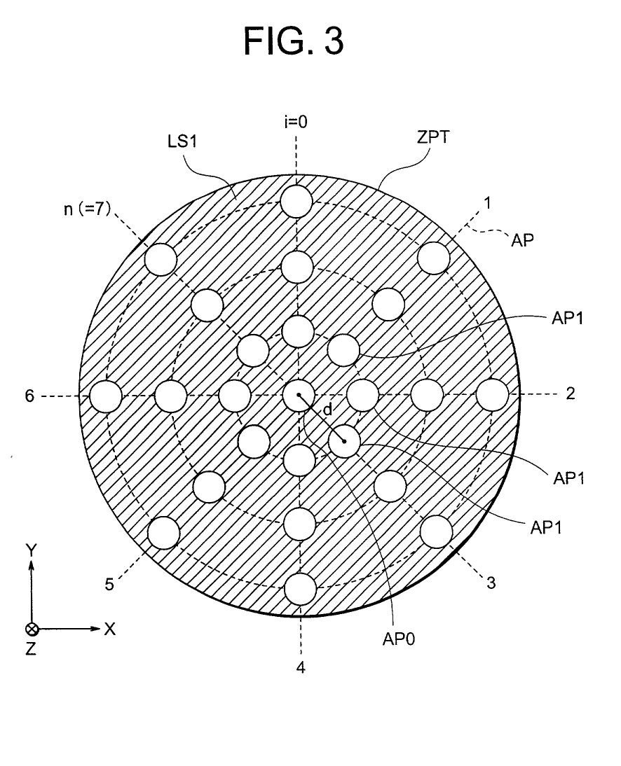

The reflection type diffractive optical element 9 will be further described with reference to FIG. 3. The pattern mask ZPT for coordinate measurement includes a plurality of circular apertures (or openings) AP. The apertures AP are arranged regularly on concentric circles with each concentric circle having n apertures AP. The center angle φ formed by a reference position i=0 and the position of the m-th aperture is as follows:

φ=m×360/(n+1)

wherein, m is a positive integer up to n (m=1, . . . , n). The lateral coordinate position of each aperture AP of the pattern mask ZPT has been measured by another coordinate measuring device or the like with high degree of accuracy and stored in advance. The pattern mask ZPT for coordinate measurement having apertures is provided adjacent to and integrally with the diffracting pattern DPT.

The pattern mask ZPT for coordinate measurement is constructed as a thin metal plate formed with apertures AP or a thin glass plate formed with a metal film layer having apertures AP. The pattern mask ZPT for coordinate measurement and the reflection type diffractive optical element 9 are integrally fixed by means of a holder (not shown).

Next, a measurement process using a reflection type diffractive optical element 9 will be described. First, the reflection type diffractive optical element 9 is placed at a position in FIG. 1 of the surface to be measured 8 instead of that surface 8. As described above, the measurement light flux is incident on the reflection type diffractive optical element 9. The light incident on the aperture of the pattern mask ZPT for coordinated measurement is diffracted by the diffracting pattern DPT and returns along the path same as the forward (or incident) path. Then the light travels along the path same as that of the measurement light flux described above and arrives at the two-dimensional image sensor 10. Thus, an image corresponding to the aperture AP is detected. The computer PC performs calculation based on the lateral coordinate position of the image of the aperture AP on the image pickup surface 10a and the lateral coordinate position of each aperture AP that has been measured with high accuracy by another coordinate measuring device in advance so as to determine their relationship.

The measurement of the reflection type diffractive optical element is effected under such an alignment condition in which the density of the interference fringes is low. As described above, the relationship between the incident angle θ on the reflection type diffractive optical element and the coordinate (i.e. lateral coordinate position) of incidence is known. So the relationship between ray emission angle θ from the Fiezeau lens 7 and the lateral coordinate on the image pickup surface 10a of the two-dimensional image sensor 10 can be obtained. If measurement of the surface to be measured is effected, since its radius of curvature (r) is a known value, the lateral coordinate rsin θ can be calculated based on its relationship with the ray emission angle from θ from the Fiezeau lens 7, so that the relationship between the lateral coordinate on the surface to be measured 8 and the lateral coordinate on the image pickup surface 10a of the two-dimensional image sensor 10 can be determined.

Based on the determined relationship of coordinates, an imaging magnification, an aspect ratio of magnification, and a coordinate distortion etc. can be detected by using data processing such as fitting.

Here, a specific description will be made of a procedure for a case in which relationship is to be determined for coordinate positions having rotation symmetry and with reference to FIG. 3. Distances d between an image of the center aperture AP0 and images of respective apertures AP1 that are arranged equidistantly from the center aperture AP0 are calculated. Then an averaging operation with respect to the distances d is effected for the apertures AP1 arranged equidistantly on the mask ZPT. With such an averaging operation, influence of the positional deviation between the optical axis AX of the Fiezeau lens 7 and the center of the pattern mask ZPT can be cancelled along with that the variation in the measurement results can be suppressed.

Returning to the description of the measurement process, the computer PC calculates, based on the relationship of lateral coordinates obtained by the above step, a conversion equation from the two-dimensional image sensor 10 to a coordinate on the surface to be measured 8. The conversion equation is stored in a memory M. On account of this, when a measurement for the surface to be measured 8 is effected, a lateral coordinate on the image pickup surface 10a of the image sensor 10 can be readily converted into a lateral coordinate on the surface to be measured 8.

Here, a description will be made of a data processing for a case in which the relationship between the lateral coordinate on the image pickup surface 10a of the two-dimensional image sensor 10 and the coordinate of the surface to be measured 8 is deviated largely from a linearly proportional relationship. In this case, in a pattern formed with a plurality of circular apertures as shown in FIG. 3, displacement between the coordinate position of the center of an aperture measured by another coordinate measuring device and the barycenter of its image becomes large due to distortion in the relationship of coordinates. In such a case, it is recommended that difference between the distance between the image of the aperture center and the optical axis and the distance between the barycenter of the aperture image and the optical axis be estimated based on the design values of the optical system of the interferometer so as to perform correction based on the estimated difference.

Since an image of an aperture is detected (or observed) with the two-dimensional sensor 10 that has a limited number of pixels, it is preferable that the barycenter of the pixels constituting the image on the image sensor 10 be detected so as to enhance accuracy of coordinate detection. It would be more preferable that the size (or diameter) of each aperture AP be determined such that an image thereof on the image pickup surface 10a covers not less than 10 (ten) pixels in order to suppress variation in detected values of barycenter coordinates.

This embodiment is directed to an example in which the invention is applied to a Fiezeau interferometer for measuring a spherical surface, but the invention can be applied also to other types of apparatus that have two-dimensional image sensor. For example, it can be applied to a null interferometer for measuring an aspherical surface. In the null interferometer, it is necessary to design the reflection type diffractive optical element in such a way that it is equivalent to the surface to be measured. This can be easily attained by the present invention.

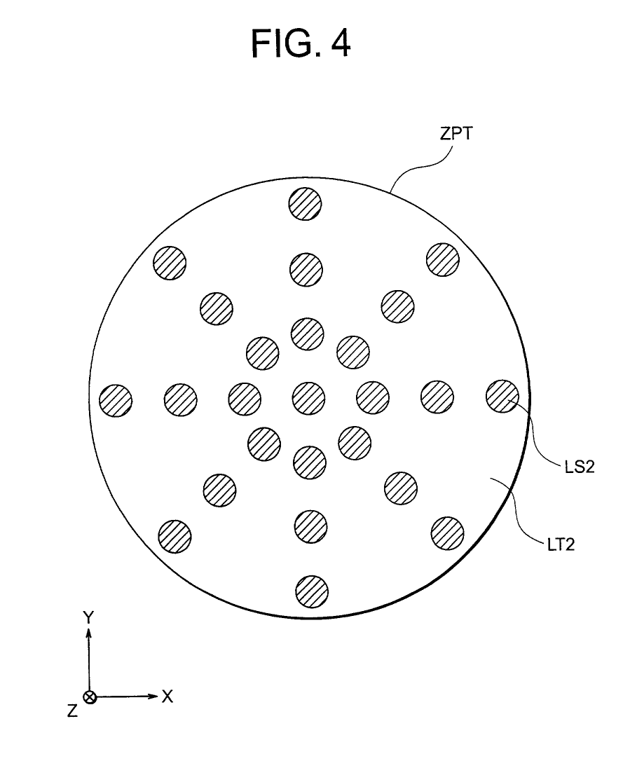

FIG. 4 shows a modification of the first embodiment. In the first embodiment shown in FIG. 3, the pattern mask ZPT for coordinate measurement has a plurality of circular apertures AP and the remaining area LS1 (hatched portion in FIG. 3) other than the circular apertures AP is a light shielding portion. In contrast to this, in the modification as shown in FIG. 4, the pattern is composed of a circular light shielding portions LS2 (hatched portions) and the remaining light transmitting portion LT2.

### SECOND EMBODIMENT

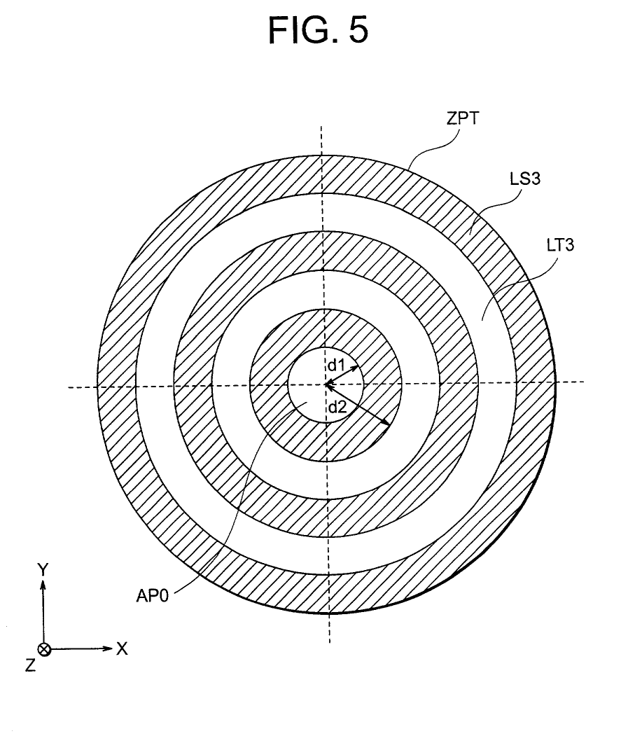

FIG. 5 is a drawing schematically illustrating a pattern mask ZPT for coordinate measurement for a surface shape measuring apparatus according to the second embodiment. Since the structures of the apparatus other than the pattern mask ZPT are the same as the first embodiment, the description thereof is omitted. In this pattern mask ZPT, a plurality of concentric annular apertures (or openings) LT3 and annular light shielding portions LS3 are alternately provided adjacent to each other around a center circular aperture AP0. In this embodiment, distances d1 between a barycenter position of an image of the center aperture AP0 and innermost boundary pixels of each annular image are calculated, and the average thereof is obtained. (This average is hereinafter referred to as “inner boundary radius”.) Distances d2 between a barycenter position of an image of the center aperture AP0 and outermost boundary pixels of each annular image are also calculated, and the average thereof is obtained. (This average is hereinafter referred to as “outer boundary radius”.) The average of the inner boundary radius and the outer boundary radius is calculated to define a median radius of that annular image. Then, relationship between this median radius and the median radius of the annular band in the pattern mask ZPT for coordinate measurement is determined. With the calculation processing described above, it is possible to reduce errors caused by influence of diffraction or the like that can make a width of an annular image larger or smaller.

As in the case of the above-described modification of the first embodiment, a circular light shielding portion may be provided at the center of the pattern mask for coordinate measurement with annular apertures and annular light shielding portions around arranged alternately adjacent to each other.

In the above-described embodiments, lateral coordinate detection patterns that are formed on pattern masks for coordinate measurement are used. But the invention is not limited to such a specific structure and the lateral coordinate detection pattern may be constituted by presence and absence of diffracting pattern in a diffractive optical element (for example, ON and OFF of diffracting pattern in a zone plate). In such a case, alignment of the diffractive optical element and the pattern mask is not required, so that more accurate measurement can be realized.

### THIRD EMBODIMENT

In the descriptions of the third and fourth embodiment presented below, parts that have the same functions and the same structures as those parts which were described above with reference to FIG. 1 will be designated with the same reference numerals as in FIG. 1.

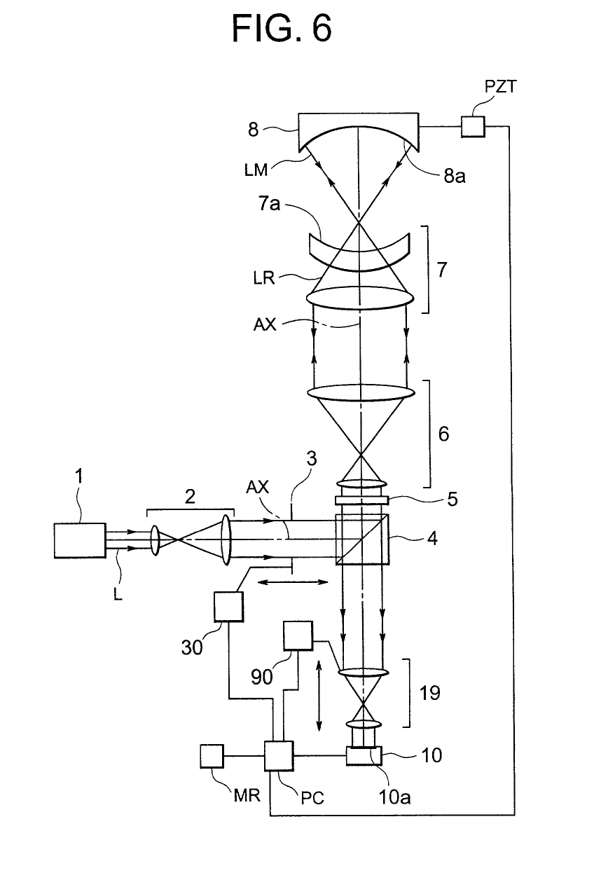

FIG. 6 is a schematic diagram of a shape measuring apparatus according to the third embodiment of the invention. A laser source 1 emits a linearly polarized light beam L. A beam expander 2 transforms a beam diameter of the light beam L. The light beam L passes through a stop 3 so that light flux diameter thereof is delimited. The stop 3 is movable in an optical axis direction AX by means of a moving mechanism 30. As will be described later, the position of the stop 3 is adjusted by the moving mechanism so that the stop 3 is conjugate with a surface to be measured 8a.

The light beam L, having been delimited with respect to its light flux diameter by the stop 3, is incident on a polarizing beam splitter (hereinafter referred to as “PBS”) 4. The polarization plane of the light beam L is so selected as to be reflected by the PBS 4. After the light beam L is reflected by the PBS, the light reaches the image pickup surface 10a of the two-dimensional image sensor 10, and the interference fringes of the reference light flux LR and measurement light flux LM is generated later as in the case of the first embodiment. Since the behavior of light in this apparatus until the interference fringes are generated is the same as that in the first embodiment, which has been described with reference to FIG. 1, a detailed description thereof will be omitted.

In this embodiment, the beam diameter transforming optical system 19 is movable in the direction of the optical axis AX by means of a moving unit 90. The moving unit 90 moves the beam diameter transforming optical system 19 to such a position at which an image of the surface to be measured 8a is formed on the image pickup surface 10a of the two-dimensional image sensor 10. Namely, the beam diameter transforming optical system 19 also functions, in addition to the function of beam diameter transformation, to form an image of the surface to be measured 8a on the image pickup surface 10a of the two-dimensional image sensor 10.

An output from the two-dimensional image sensor 10 is fetched and analyzed by a computer PC so that a phase distribution of the interference fringes is calculated. The calculation result is stored in a memory M.

In the surface shape measuring apparatus of this embodiment, it is preferable that the surface to be measured 8 be slightly shifted in the direction of an optical axis AX by a piezoelectric element PZT so that the phase distribution of the interference fringes be obtained with a high degree of accuracy by means of a well known phase shift interferometry method.

As described above, the stop 3 is adjusted by the moving mechanism 30 so that it is positioned to be conjugate with the surface to be measured. In the following, two examples (1) and (2) for this adjustment process will be described.

(1) The position of the surface to be measured 8a is calculated by the computer PC based on data such as a radius of curvature of the surface to be measured. A specific position of the stop 3 at which the stop 3 is conjugate with the surface to be measured 8a is calculated using ray tracing method. Then, the moving mechanism 30 moves the stop 3 to the specific position in accordance with a signal from the computer PC.

(2) A mask is provided on the surface to be measured 8a disposed at measurement position. In the beam diameter transforming optical system 19, a lens group is shifted so that the mask is brought into focus on the image pickup surface 10a of the image sensor 10. Then, the mask is taken away from the surface to be measured 8a. And then, the moving mechanism moves the stop so that the surface to be measured 8a and the stop are placed to be conjugate with each other, in other words, so that an image of the surface to be measured 8a and an image of the stop 3 are formed on the image pickup surface.

As described above, an image of the stop 3 is formed on the surface to be measured by making the stop and the surface to be measured 8a conjugate with each other. Furthermore, an image of the surface to be measured 8a is formed on the image pickup surface 10a of the two-dimensional image sensor 10. So the area of wavefront disturbance at a peripheral portion can be minimized as if a stop were formed on the surface to be measured 8a. Thus, the surface shape measuring apparatus according to the present embodiment attains an advantageous effect that diffraction phenomena at the stop 3, especially wavefront disturbance due to Fresnel diffraction can be minimized. As a result, a phase distribution of interference fringes formed by the reference and measurement light fluxes can be obtained with high degree of accuracy, so that a highly accurate measurement of surface shape is possible.

### FOURTH EMBODIMENT

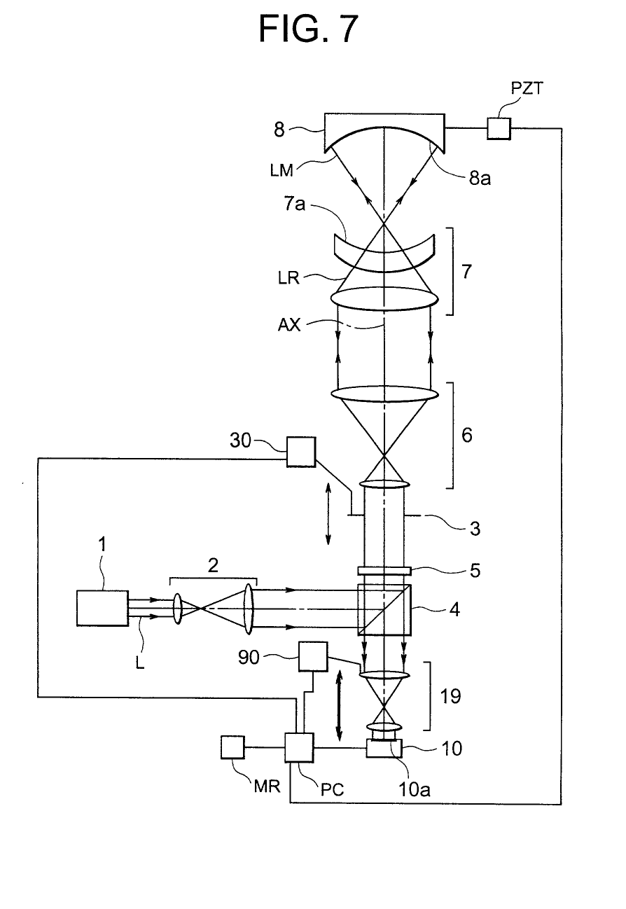

FIG. 7 is a schematic diagram of a surface shape measuring apparatus according to the fourth embodiment of the invention. In the surface shape measuring apparatus according to this embodiment, the stop 3 in the third embodiment is transposed to a space between the PBS 4 and the beam expander 6. Since the other structures are the same as the third embodiment, those parts in FIG. 7 which are the same as those in FIG. 6 have been given the same numerals and the description thereof is omitted.

The stop 3 can be moved by the moving mechanism 30 in the direction of the optical system AX in accordance with a process similar to those described in connection with the third embodiment. Thus, the stop 3 is adjusted by the moving mechanism 30 to be in a position at which it is conjugate with the surface to be measured 8a.

### FIFTH EMBODIMENT

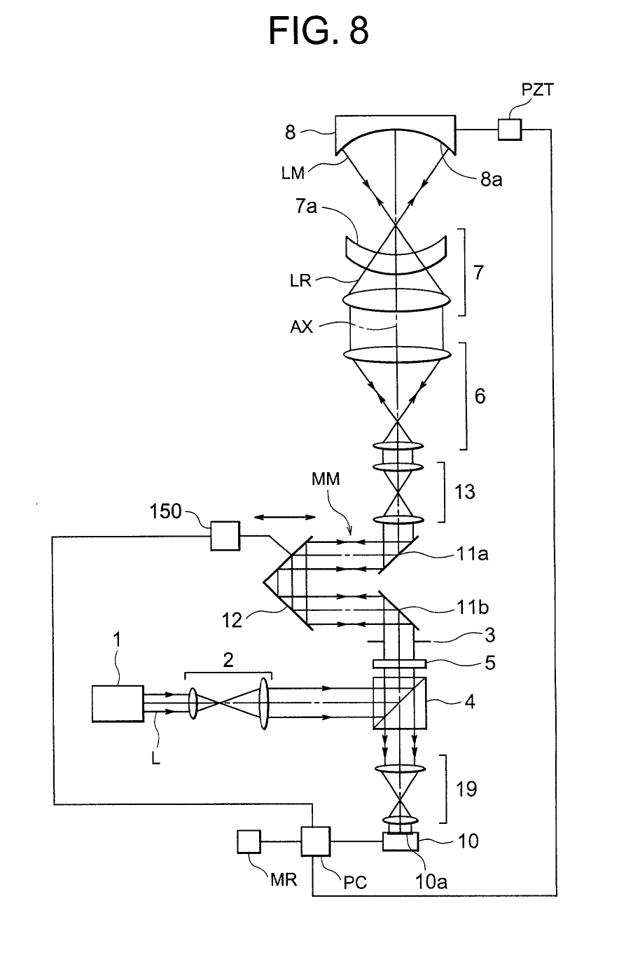

FIG. 8 is a schematic diagram of a shape measuring apparatus according to the fifth embodiment of the invention. In the surface shape measurement apparatus according to this embodiment, the stop 3 is fixedly disposed at a position similar to that in the fourth embodiment. The apparatus further includes in a space between the stop 3 and the beam expander 6, a reflecting mirror optical system MM composed of reflecting mirrors 11a and 11b and a double reflecting mirror unit 12 in which two reflecting surfaces are arranged to be substantially orthogonal. Since the other structures are the same as the third and fourth embodiments, those parts in FIG. 8 which are the same as those in FIGS. 6 and 7 have been given the same reference signs and the description thereof is omitted.

In the reflecting mirror optical system MM, the double reflecting mirror unit 12 is movable in a direction indicated by an arrow in FIG. 8 by means of moving mechanism 150. The computer PC causes the double reflecting mirror unit 12 to move to a position at which the stop 3 and the surface to be measured 8a are conjugate with each other in accordance with the above-described process (1) or (2) for bringing the stop 3 and the surface 8a conjugate with each other. In this way, the optical path length between the surface to be measured 8a and the stop 3 can be varied.

A relay lens system 13 is disposed between the beam expander 6 and the reflecting mirror optical system MM. The relay lens system 13 functions to relay the conjugate position of the image under the presence of the reflecting mirror optical system MM in the optical path.

As described above, in the third and the fourth embodiments, the beam diameter transforming optical system 19 also functions to form an image of the surface to be measured 8a on the image pickup surface 10a of the two-dimensional image sensor 10. In the present embodiment, the stop 3 is fixedly provided between the PBS 4 and the beam expander 6. So the beam diameter transforming optical system 19 can be fixed at a position at which it makes the stop 3 and the image pickup surface 10a of the two-dimensional image sensor 10 conjugate with each other. This brings about an advantageous effect, in addition to those effects mentioned in connection with the third and fourth embodiments, that the number of movable parts can be reduced, since the beam diameter transforming optical system need not be constructed to be movable.

When the beam diameter transforming optical system 19 is movable, the relationship between the lateral coordinate of the surface to be measured 8a and that of the image pickup surface 10a might vary. But in the present embodiment, the beam diameter transforming optical system 19 is fixed, so that the above-mentioned relationship can be maintained unchanged.

In the present embodiment, the reflecting mirror optical system MM is disposed between the PBS 4 and the beam expander. But the invention is not restricted to this particular arrangement, and the reflecting mirror optical system MM can be applied to the structure of the third embodiment. In this case, the reflecting mirror optical system MM may be disposed between the stop 3 and PBS 4 with the stop 3 being fixed.

The third to fifth embodiments are examples in which the invention is applied to the Fiezeau interferometers, but the present invention can be applied to other types of interferometers such as a twyman-green interferometer etc.

According to the present invention, it is possible to produce or manufacture optical members using the surface shape measuring apparatus in accordance with the above-described embodiments. For example, a projecting lens to be built in a projection optical system for use in a projection exposure apparatus can be produced. Namely, the invention is advantageous in that it can provide high precision optical members.

With the first invention, it is easy to determine a correspondence or relationship between the lateral coordinate of a pattern of a reflection type diffractive optical element and the lateral coordinate on an image pickup surface of a two-dimensional image sensor. This enables a highly accurate surface shape measurement of an optical element such as a lens or mirror. Furthermore, the invention is also advantageous in a measurement process of an aspherical surface such as a process using a null lens, since the correspondence between coordinates can be determined with a high degree of accuracy, so that precision of a surface under grinding processing can be easily enhanced.

With the second invention, wavefront disturbance due to diffraction at a stop can be suppressed minimum. As a result, a phase distribution of interference fringes generated by a reference light flux and a measurement light flux can be determined with a high degree of accuracy. This can realizes a surface shape measuring apparatus or the like that can measure a surface shape of an optical element such as a lens or mirror etc. Especially, the invention realizes a surface shape measuring apparatus that can measure a surface having a small radius of curvature with a high degree of accuracy.

With the third invention, it is possible to produce optical members using the surface shape measuring apparatus in accordance with the above-described embodiments. For example, a projecting lens to be built in a projection optical system for use in a projection exposure apparatus can be produced. Namely, the invention is advantageous in that it can provide high precision optical members or elements.

What is claimed is:

1. A lateral coordinate calibration method for a surface shape measuring apparatus which measures a shape of a surface to be measured by causing a measurement light reflected from the surface to be measured and a reference light to interfere with each other and detecting with a detector a phase difference through the interference, the method comprising the steps of:
providing a reflecting optical element formed with a specific pattern and designed to generate a reflection wavefront substantially the same as said measurement light, and generating an interference image of said reflection wavefront from said reflecting optical element and said reference light on a detection surface of said detector;
detecting lateral coordinate information of an image of said specific pattern on said detection surface which is formed in connection with the generation of said interference image;
calculating a relationship between lateral coordinate information of said specific pattern on said reflecting optical element and the lateral coordinate information of an image of said specific pattern on said detection surface.

2. A lateral coordinate calibration method for a surface shape measuring apparatus according to claim 1, wherein said reference light is a reflection light from a reference surface.

3. A lateral coordinate calibrating method for a surface shape measuring apparatus according to claim 1 or 2, wherein said reflecting optical element comprises a reflection type diffractive optical element.

4. A lateral coordinate calibrating method for a surface shape measuring apparatus according to claim 3, wherein said specific pattern comprises a pattern composed of presence and absence of a diffracting pattern formed on said reflection type diffractive optical element.

5. A lateral coordinate calibrating method for a surface shape measuring apparatus according to claim 1, wherein said specific pattern comprises a pattern composed of a plurality of apertures.

6. A lateral coordinate calibrating method for a surface shape measuring apparatus according to claim 1, wherein said specific pattern comprises a pattern composed of a plurality of light shielding portions.

7. A lateral coordinate calibrating method for a surface shape measuring apparatus according to claim 1, wherein said specific pattern comprises a pattern composed of a plurality of annular apertures and annular light shielding portions that are alternately and concentrically provided adjacent to each other.

8. An optical member having been measured using a lateral coordinate calibrating method for a surface shape measuring apparatus according to claim 1 or 2.

9. A surface shape measuring apparatus which measures a shape of a surface to be measured by causing a measurement light reflected from the surface to be measured and a reference light to interfere with each other and detecting with a detector a phase difference through the interference, comprising:
reflecting optical element formed with specific pattern and designed to generate a reflection wavefront substantially the same as said measurement light so as to generate an interference image;
a calculator which calculates a relationship between lateral coordinate information of said specific pattern on said reflecting optical element and the lateral coordinate information of an image of said specific pattern on said detection surface.

10. A surface shape measuring apparatus according to claim 9 further comprising a memory portion which stores said relationship.

11. A surface shape measuring apparatus according to claim 9 or 10, wherein said reference light is a reflection light from a reference surface.

12. A surface shape measuring apparatus which measures a shape of a surface to be measured by causing a measurement light reflected from the surface to be measured and a reference light reflected from a reference surface to interfere with each other and detects a phase difference through the interference, the apparatus comprising a stop disposed at a position conjugate with said surface to be measured.

13. A surface shape measuring apparatus according to claim 12, wherein said stop is provided with an adjusting member.

14. A surface shape measuring apparatus according to claim 13, wherein said adjusting member comprises a moving unit which moves said stop to the position conjugate with said surface to be measured.

15. A surface shape measuring apparatus according to claim 13, wherein said adjusting member comprises a plurality of reflecting mirror portions and a mirror moving portion which moves the reflecting mirror portions in such a way that said stop and said surface to be measure are conjugate with each other.

16. An optical member having been measured using the surface shape measuring apparatus according to any one of claims 12 to 15.
